(19) United States
(12) Patent Application Publication
(10) Pub. No.: US 2025/0117690 A1
(43) Pub. Date: Apr. 10, 2025

(54) DRONE DETECTION USING MODIFIED ONE-STAGE OBJECT DETECTORS

(71) Applicant: Mohamed bin Zayed University of Artificial Intelligence, Abu Dhabi (AE)

(72) Inventors: Mohamad KASSAB, Abu Dhabi (AE); Abdulmotaleb ELSADDIK, Abu Dhabi (AE); Min XU, Abu Dhabi (AE)

(73) Assignee: Mohamed bin Zayed University of Artificial Intelligence, Abu Dhabi (AE)

(21) Appl. No.: 18/482,372

(22) Filed: Oct. 6, 2023

(51) Int. Cl. G06V 20/52; G06V 10/40; G06V 10/764; G06V 10/82

(52) U.S. Cl. CPC G06N 20/00; G06V 20/00

(57) ABSTRACT

An object detection system that can detect drone objects with high accuracy and low computational complexity, includes a camera for capturing an image, processing circuitry, and a display device. The processing circuitry is configured to input the image. The processing circuitry includes a machine learning network, having a feature extraction backbone with addition-based filters that use addition as a similarity measure to extract features of the image, a path to add low-level features to high-level features, and a single shot detector (SSD) network that outputs an image with possible classes of an object in the image based on the extracted features. The display device displays the image with a label for the detected object based on a selected class. The SSD network backbone can be configured with a SWIN transformer to extract features. The SWIN transformer includes a shifted window self-attention and allows training the SSD model with dynamic image sizes.

### STATEMENT OF PRIOR DISCLOSURE BY AN INVENTOR

Aspects of the present disclosure are described in Mohamad Kassab et al., “Bird/Drone Detection and Classification using Classical and Deep Learning Methods,” ResearchGate 2023 which is incorporated herein by reference in its entirety.

### BACKGROUND

### Technical Field

The present disclosure is directed to a system and method of drone detection.

### Description Of Related Art

Unmanned Ariel Vehicles (UAVs), or drones, are becoming more accessible and practical. It is noted that for purposes of this disclosure, the terms UAV and drone are used interchangeably. UAVs are being utilized in many applications including surveillance, military use, commercial use, and personal use. The global commercial drone market was estimated at USD 19.89 billion in 2022 and is expected to grow at a compound annual growth rate of 13.9% from 2023 to 2030. The market growth is attributed to the increasing enterprise application of drones across various industry verticals. Also, in terms of quantity, there were 865,505 drones registered as of October 2022, with 538,172 of them being recreational. The wide availability of drones has lead governments to impose restrictions and laws that regulate their use. However, the threats posed by drone usage remain critical to air traffic. See James O'Malley, “The no drone zone,” Engineering & Technology, vol. 14, no. 2, pp. 34-38, 2019. Furthermore, drones can be utilized unethically to pursue activities which can threaten public safety. See Alyssa Sims, “The rising drone threat from terrorists,” Geo. J. Int'l Aff., vol. 19, pp. 97, 2018.

Although many techniques have been proposed in literature, drone detection remains a challenging task. The challenges in drone detection are due to the similarity between drones and birds in terms of their size, maneuvering capabilities, and flying altitude. The challenges in drone detection also include crowded backgrounds, unstable weather conditions, and the relatively small size of drones. See Farzaneh Dadrass Javan, Farhad Samadzadegan, Mehrnaz Gholamshahi, and Farnaz Ashatari Mahini, “A modified yolov4 deep learning network for vision-based uav recognition,” Drones, vol. 6, no. 7, pp. 160, 2022. The experimental results presented in a UAV benchmark showed that two-stage detectors are the best when dealing with small drone images, however, one-stage detectors are more practical due to their detection speed. See Brian K. S. Isaac-Medina, Matt Poyser, Daniel Organisciak, Chris G. Willcocks, Toby P. Breckon, and Hubert P. H. Shum, “Unmanned aerial vehicle visual detection and tracking using deep neural networks: A performance benchmark,” arXiv, 2021.

In the drone literature, 75% and more of the published papers in top conferences are concerned mainly with accuracy. See Roy Schwartz, Jesse Dodge, Noah A Smith, and Oren Etzioni, “Green ai,” Communications of the ACM, vol. 63, no. 12, pp. 54-63, 2020. The advancements in accuracy are usually associated with an increase of complexity and limited effective work is being done to reduce the computational complexity. In addition to that, performance must be a function of both computational complexity and accuracy. See Mohammad Rastegari, Vicente Ordonez, Joseph Redmon, and Ali Farhadi, “Xnor-net: Imagenet classification using binary convolutional neural networks,” in European conference on computer vision. Springer, 2016, pp. 525-542.

Many methods have been proposed in literature to tackle the challenges faced in drone detection. However, most of these models are trained and tested on simple datasets.

It was recently proposed to replace normal convolutional filters with filters that utilize addition (AdderNet filters) instead of multiplications. See Hanting Chen, Yunhe Wang, Chunjing Xu, Boxin Shi, Chao Xu, Qi Tian, and Chang Xu, “Addernet: Do we really need multiplications in deep learning?,” in Proceedings of the IEEE/CVF conference on computer vision and pattern recognition, 2020, pp. 1468-1477. The proposed AdderNet filters utilize addition and subtraction as a similarity measure and full precision gradients to update weights, which achieved comparable results in classification tasks to the state-of-the-art models. However, this method was not well tested on object detection tasks and specifically small objects such as the ones faced in drone detection tasks.

A hierarchical architecture vision transformer (SWIN Transformer) which can serve as a general purpose backbone for computer vision tasks was also proposed. See Ze Liu, Yutong Lin, Yue Cao, Han Hu, Yixuan Wei, Zheng Zhang, Stephen Lin, and Baining Guo, “Swin transformer: Hierarchical vision transformer using shifted windows,” in Proceedings of the IEEE/CVF international conference on computer vision, 2021, pp. 10012-10022. The proposed transformer architecture takes into consideration the differences between language tasks and computer vision tasks by utilizing a shifted windowing mechanism that limits self attention to non-overlapping local windows and allows connections between windows. As stated in Liu et al., SWIN transformer was able to achieve beneficial outcomes when tested on various computer vision tasks, hence, enabling the use of transformers as feature extractors.

Accordingly, it is one object of the present disclosure to provide methods and systems for drone detection with reduced computational complexity.

### SUMMARY

An aspect of the present disclosure is an object detection system, that can include a camera for capturing an image; processing circuitry configured to input the image, a machine learning network, including a feature extraction backbone having addition-based filters that use addition as a similarity measure to extract features of the image, a path to add low-level features with high-level features, and a single shot detector (SSD) network that outputs an image with possible classes of an object in the image based on the extracted features; and a display device to display the image with a label for the detected object based on a selected class.

A further aspect of the present disclosure is an object detection system that can include a camera for capturing an image; processing circuitry configured with a single-shot detector (SSD) network backbone for extracting features of the captured image, and a SSD network head that outputs classes of the object in the image based on the extracted features, wherein the SSD network backbone uses a SWIN transformer to extract features, wherein the SWIN transformer includes a shifted window self-attention; and a display device to display the image having a label for the detected object based on the output class.

A further aspect of the present disclosure is a method of detecting an object in an image, that can include capturing, via a camera, an image; inputting, via processing circuitry, the image; extracting, via the processing circuitry, using a backbone network features of the image by using addition as a similarity measure; determining, via the processing circuitry, using a head network an image with possible classes of an object in the image based on the extracted features; and displaying, via a display device, the image with a label for the detected object based on a selected class.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1A and 1B illustrate RGB and IR images, respectively, containing a drone;

FIG. 2 is a schematic diagram of a modified SDD network architecture, in accordance with an exemplary aspect of the disclosure;

FIG. 3 is a schematic diagram of a single-shot detector network architecture;

FIG. 4 is a schematic diagram for a network architecture for a deep convolutional network for image recognition;

FIGS. 5A-5D is a schematic diagram for a network architecture for a vision transformer network with a shifted window approach for computing self-attention;

FIGS. 6A, 6B illustrate RGB and IR images, respectively, containing a drone.

FIG. 7 is a system diagram for machine learning and inference;

FIG. 8 is a block diagram of a computer system configured for machine learning;

FIGS. 9A and 9B are end user devices for use in drone detection, in accordance with exemplary aspects of the disclosure; and

FIG. 10 is a block diagram of a mobile device for drone detection.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system, device, and method for small object detection, in particular drone detection. An aspect is a single-shot detector (SSD) having a convolutional neural network (CNN) that is incorporated with adder network filters as a backbone. The backbone includes a path to add low-level features to high-level features. In an alternative arrangement, a SWIN transformer is the backbone for the SSD detector and allows training the SSD model with dynamic image sizes.

The combining of low-level features with high-level features was found to increase the detection accuracy on small objects as some of the drones are very small and it is believed that the information will be lost as the convolutional network gets deeper. The alternative model that is created utilizing a SWIN transformer as a feature extractor has been used to investigate the applicability of transformers as feature extractors for drone detection task.

The integration of adder network filters (referred to as AdderNet filters) with the backbone of SSD model was found to significantly reduce the computational complexity by 90.4G multiplications and enhance real-time drone detection. The structure to add low-level features with high-level features has been found to increase the detection performance of small objects. The significant reduction in computational complexity enabled training and testing with large scale datasets containing more than 100,000 images. Training with such large datasets has led to results that are more reliable compared to models tested on simple datasets. The disclosed methods have been found to achieve similar performance to other state-of-the-art approaches while achieving a significant decrease in computational complexity.

In this disclosure, a small object is an object that is small in an image, either because the object is small in physical size, or because the object is far away in distance, or both. As an example, a small object occupies 10% or less of a total image area, preferably less than 5%, 2%, 1%, 0.5%, 0.1% or 0.01% a total image area. In other words, a small object is not limited to a physical size. As an example, a helicopter may appear small in an image, when the helicopter is high above the ground. In another example, a balloon just a few hundred feet above ground may be indistinguishable to the eye from a dirigible airship that is several thousand feet above ground, or a hot air balloon that is a few miles away.

Objects that are far away are difficult to identify by people or computer-based imagery methods. Physically small objects are especially difficult to identify due to relatively fewer features. Also, physically small objects may be included in an image that is cluttered by other objects at various distances. In either case, the object to be identified occupies only a small portion of a total image.

In this disclosure, a drone and an unmanned aerial vehicle (UAV) are used to depict the same vehicle. In either case, the drone is a small arial vehicle that is unmanned and is capable of maneuvering in a vertical direction, horizontal direction (latitudinal and longitudinal), and can maintain a stationary position above ground. The drone may be equipped with sensors, including, but not limited to, a video camera, global positioning system (GPS), altitude measurement device, speedometer, accelerometer, humidity measurement device, thermometer, as well as communications equipment, and an embedded controller.

There are several different types of drones. A multi-rotor drone can include three or more rotors (typically, 3, 4, 6, or 8 rotors), mounted overhead, and driven by variable speed motors. A fixed-wing drone has one rigid wing, similar to an airplane. A single-rotor drone is similar to helicopters. A single-rotor has just one rotor, which is like one big spinning wing, plus a tail rotor to control direction and stability. A fixed-wing drone does not hold itself stationary in the air. Hybrid VTOL drone types merge the benefits of fixed-wing and rotor-based designs. This drone type has rotors attached to the fixed wings, allowing it to hover and take off and land vertically. One example of fixed-wing hybrid VTOL is Amazon's Prime Air delivery drone.

Drones come in different sizes. Small drones are light-weight and small, but are not for performing commercial functions and may be unstable. Micro drones include micro cameras but are limited in fly time and range, Tactical drones are somewhat larger, on the order of about 4 to 5 feet in length, and can be equipped with GPS and infrared cameras for performing surveillance. Photography drones are outfitted with professional-grade cameras. 4K camera drones can take high-resolution pictures. These drone types make use of automated flight mode and precision stability to take pictures covering vast spaces.

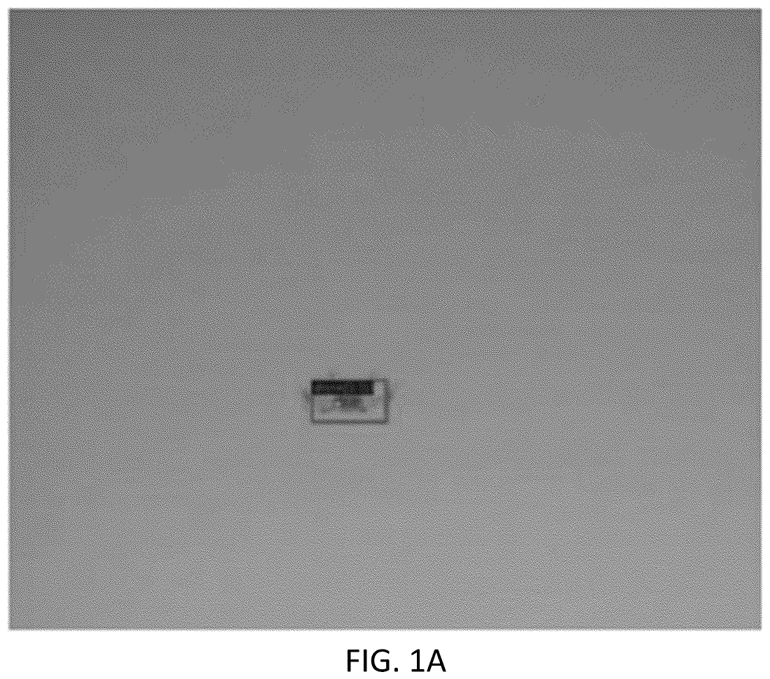

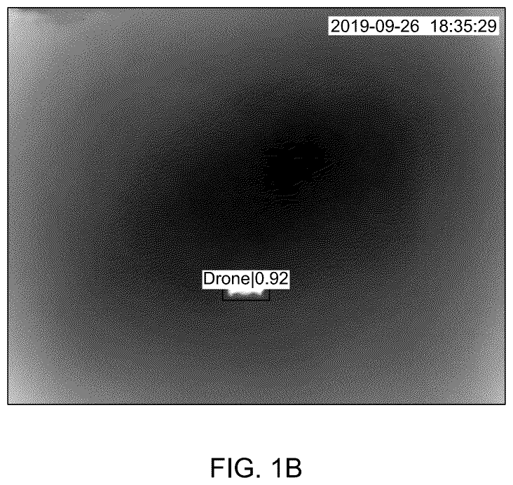

FIGS. 1A and 1B illustrate images that include a drone in an empty background. FIG. 1A is an RGB image. FIG. 1B is in infrared image. Even in the case of an image with an empty background, the drone is small relative to the image size, making it difficult to determine whether the object is a drone or another flying object, such as a bird, helicopter, or airplane.

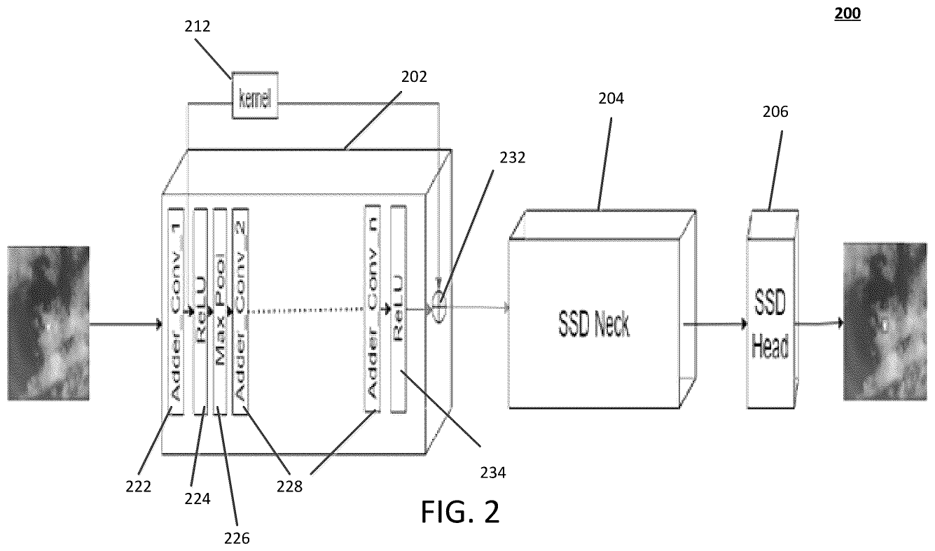

FIG. 2 is a schematic diagram of a modified SSD utilizing AdderNet filters in the CNN backbone, with the inclusion of a path that adds low-level features with high-level features. In order to describe the modified SSD of FIG. 2, the arrangements of a SSD architecture and a VGG-16 architecture are first described.

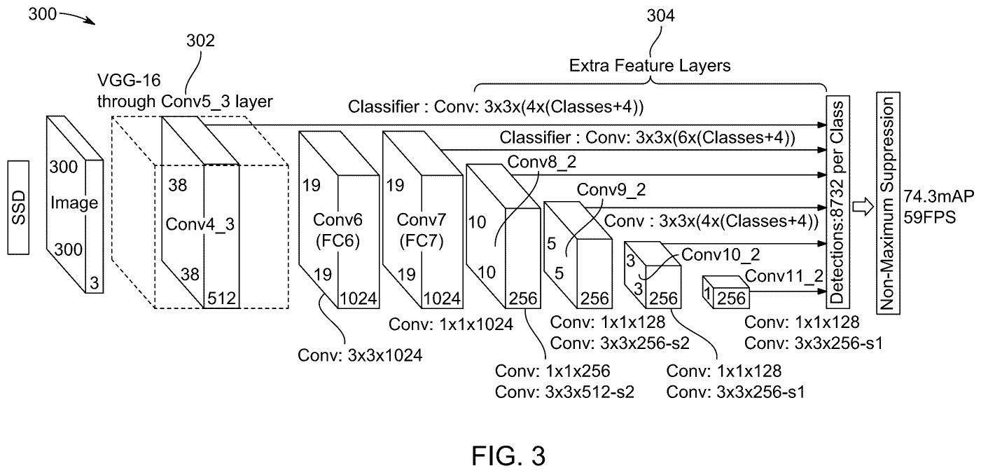

FIG. 3 is a schematic diagram of a SSD architecture. The SSD model is based on feed-forward convolutional network. It produces fixed-sized bounding boxes and scores if an object class instance is present in those boxes. During final predictions, a Non-maxima suppression algorithm is used. SSD 300 consists of two parts—a backbone model 302 and SSD head 304. The Backbone 302 is a pre-trained image classification architecture, truncated before any classification layers, which acts as a feature extractor. In an example embodiment, the Backbone 302 can use the VGG-16 network. The SSD head 304 is an additional layer on top the backbone model which predicts the offsets to default boxes of different scales and aspect ratios and their associated confidences. These layers decrease in size progressively and allow predictions of detections at multiple scales.

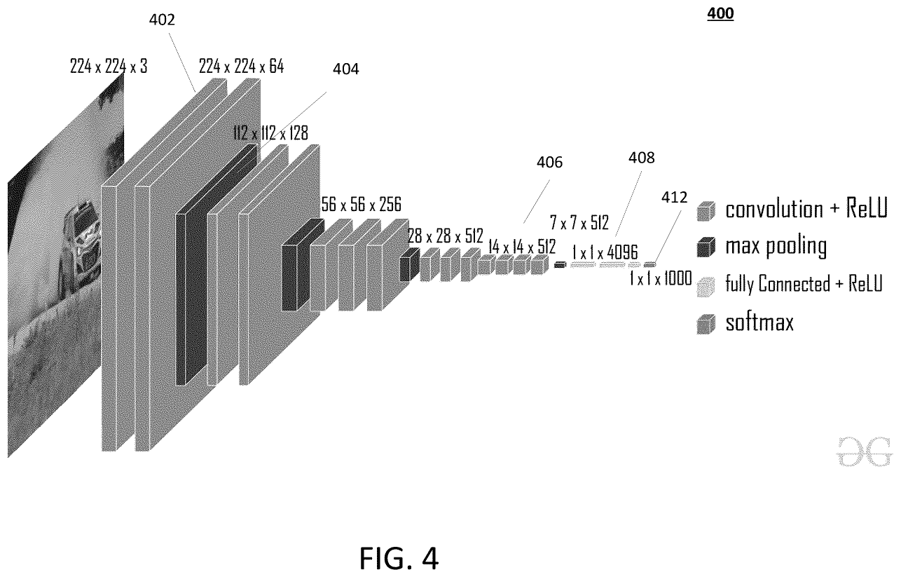

FIG. 4 is a schematic diagram of the VGG-16 network. The VGG-16 network 400 includes an Adder Convolution 402→ReLU activation→Max Pool 404. the Adder convolution 402 in the first layer can accept images of sizes, including 224×224×3, 512×512×3. The layers 402 are repeated 15 times with the same architecture while reducing the spatial dimensions of the image using the max pool 404, and increasing the number of channels as the network gets deeper. The output of the final Adder convolution layer 406 of the VGG16 has dimensions of sizes, including 14×14×512, 42×42×1024, and it has the output of the first Adder convolution embedded in it after passing it through an attention layer 408 to focus on the low-level features. VGG-16 further includes a softmax layer 412.

The AdderNet filters eliminate the use of multiplications in CNNs by utilizing addition and subtractions. However, as will be described further below, during the training phase, it was determined that AdderNet filters are extremely sensitive to weight change as the loss had reached infinity unexpectedly at a certain point. Subsequently, experiments were made by training using various hyperparameter values. For example, the learning rate was set to different values to ensure stability.

AdderNet filters 222 are implemented such that the similarity measure Y in the forward path used to extract features in AdderNet filters is l₁ distance as provided in eq 1.

$$Y ( m , n , t ) = - {\sum }_{i = 0}^{d} {\sum }_{j = 0}^{d} {\sum }_{k = 0}^{{c}_{i n}} \vert X ( m + i , n + j , k ) - F ( i , j , k , l ) \qquad ( 1 )$$

Where m is the width of kernel, n is the height of kernel, i and j are summation variables of size R^{d×d}, and k is the depth. The backpropagation for training in AdderNet filters is performed as follow.

$$\frac{dY ( m , n , t )}{d X ( m + i , n + j , k )} = HTF ( ( i , j , k , l ) - X ( m + i , n + j , k ) ) \qquad ( 2 )$$

HT is a HardTanh used to limit the gradients between −1 and 1 to avoid exploding gradients. As noted above the modified SDD network replaces the convolutional filters inside a VGG16 backbone by AdderNet filters. The aim is to decrease the computational complexity of the overall SSD model by reducing the number of multiplications.

To preserve the accuracy of detection on small objects, a path 212 adds 234 low-level features to high-level features is integrated into the backbone 202 of the modified SSD network 200. The addition of the features was done according to eq. 3.

$${Y}_{i = n} = {Y}_{i = n} + ℱ ( {Y}_{i = 1} ) \qquad ( 3 )$$

Where Y is the final output of the backbone model 202, i is the current layer where i≤n, and [symbol] is a kernel matching the dimensions of the last layer with the initial layer without changing the information extracted from the initial layer. The disclosed model is shown in FIG. 2.

During the training phase, it was determined that AdderNet filters are extremely sensitive to weight change as the loss reached infinity unexpectedly at a certain point. Therefore, a small subset of the dataset was tested on the original modified model which is a ResNet20. The training was done for 50 epochs and the loss of the model showed many spikes. Hence, it was concluded that AdderNet filters are extremely sensitive to the change of weight and may behave unexpectedly at each iteration.

Therefore, to ensure stable training of the proposed model, training trials were conducted such that the learning rate was set to different values at each trial to achieve stability. The values for the learning rate for each trial included a large value (2×10⁻²), a small value (2×10⁻⁷), a value in between (2×10⁻⁴), an adaptive learning rate, and a decaying learning rate from 2×10⁻³ to 2×10⁶. The trial with the highest stability and performance was achieved with the decaying learning rate from 2×10⁻³ to 2×10⁻⁶ using a stochastic gradient descent (SGD) optimizer with a momentum of 0.9 and a weight decay of 5×10⁻⁴.

The number of multiplications eliminated compared to the original SSD model is used as a complexity measure to highlight the benefit of replacing normal CNN kernels with AdderNet filters. The number of multiplication NoM can be defined as follows.

$$N o M = k * k * {C}_{i n} * {C}_{out} * {H}_{out} * {W}_{out} \qquad ( 4 )$$

Where k is the kernel size, Cᵢₙ is the input channel size, Cₒᵤₜ is the output channel size, Hₒᵤₜ is the height of the output, and Wₒᵤₜ is the width of the output. The number of multiplication/layer eliminated/layer is shown in Table 1. The advantage of using AdderNet filters to replace normal multiplication operation eliminates a total of 90.4G multiplication per image.

TABLE 1
NoM/Layer

| Conv Layer | k | Cᵢₙ | Cout | Hout | Wout | NoM |
|---|---|---|---|---|---|---|
| Conv 1-1 | 3 | 3 | 64 | 512 | 512 | 0.45 G |
| Conv 1-2 | 3 | 64 | 64 | 512 | 512 | 9.66 G |
| Conv 2-1 | 3 | 64 | 128 | 256 | 256 | 4.83 G |
| Conv 2-2 | 3 | 128 | 128 | 256 | 256 | 9.66 G |
| Conv 3-1 | 3 | 128 | 256 | 128 | 128 | 4.83 G |
| Conv 3-2 | 3 | 256 | 256 | 128 | 128 | 9.66 G |
| Cony 3-3 | 3 | 256 | 256 | 128 | 128 | 9.66 G |
| Cony 4-1 | 3 | 256 | 512 | 64 | 64 | 4.83 G |
| Conv 4-2 | 3 | 512 | 512 | 64 | 64 | 9.66 G |
| Conv 4-3 | 3 | 512 | 512 | 64 | 64 | 9.66 G |
| Conv 5-1 | 3 | 512 | 512 | 32 | 32 | 2.42 G |
| Conv 5-2 | 3 | 512 | 512 | 32 | 32 | 2.42 G |
| Conv 5-3 | 3 | 512 | 512 | 32 | 32 | 2.42 G |
| Conv 6-1 | 3 | 512 | 1024 | 42 | 42 | 8.32 G |
| Conv 6-2 | 1 | 1024 | 1024 | 42 | 42 | 1.85 G |

In an alternative arrangement, a SWIN transformer is the backbone for the SSD detector. The output features obtained from the backbone have input channels of 192, 384, and 768 respectively. The optimizer used with the model is AdamW with a learning rate of le-4, beta values of 0.9 and 0.999, and a weight decay of 0.05. The feature maps obtained from the backbone are further processed by the SSD neck 204 and SSD head 206 to obtain the final prediction.

The model created utilized the SWIN transformer as a backbone 202 together with a residual block to avoid saturation in the performance.

Some key concepts in SWIN transformer that makes it more suitable for vision tasks than a Vision Transformer (ViT) are hierarchical feature maps, patch merging, and shifted window self-attention. The hierarchical feature maps allow the model to merge feature maps from one layer to another, hence, enhance the resolution through its architecture. The patch merging algorithm allows the model to downsample without using CNNs. The shifted window self-attention reduces complexity from being quadratic with respect to the image size to being linear with respect to the image size, and allows training the SSD model with dynamic image sizes.

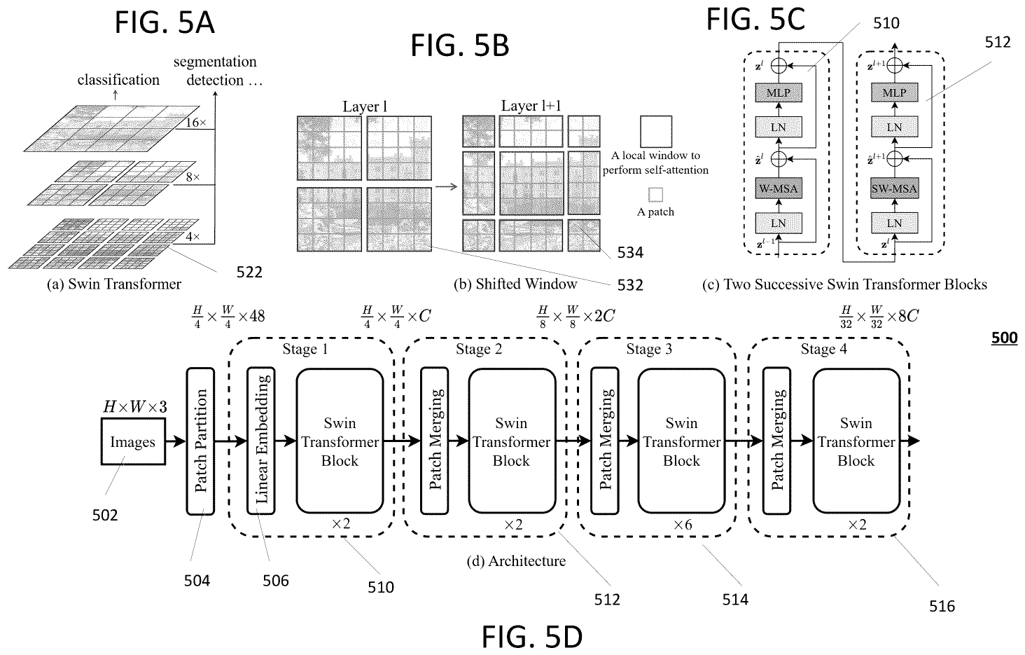

FIGS. 5A-5D are a schematic diagram of a SWIN transformer. In FIG. 5D, the SWIN transformer 500 can receive images 502 of size H×W×3 (e.g., 512×512×3) and then perform Patch Extraction 504 to divide the input image into a grid of fixed-size patches 522. Each patch typically contains a small square region of pixels from the original image. This patch extraction process 504 allows the model to process local image information efficiently. Following that, Patch Embedding 506 is used to linearly project to a higher-dimensional space which converts the 2D image patches into sequences of vectors, allowing subsequent Transformer layers (512, 514, 516) to operate on them.

Regarding FIG. 5B, the images are passed through a SWIN Transformer Block 510 which has a Window-Multi-Head-Self-Attention layer 532 and a Shifted-Window-Multi-Head-Self-Attention layer 534. The shifted window self-attention in SWIN transformer computes self-attention of an element with its neighbors within a window of size M×M. Then, the window is shifted 534 by a factor of M/2 and the gaps are filled by moving the patches into the empty spaces. The complexity of Multi-Head Self-Attention is quadratic with the spatial dimensions of the input image. However, the Window-Multi-Head Self-Attention is linear with the spatial dimensions of the input image, and allows training the SSD model with dynamic image sizes.

### Datasets Used

To train, test, and compare the models that created for comparison, two datasets can be used. First, is an RGB dataset called Drone-Vs-Bird. See Angelo Coluccia, Alessio Fascista, Arne Schumann, Lars Sommer, Anastasios Dimou, Dimitrios Zarpalas, Miguel Méndez, David De la Iglesia, Iago González, Jean-Philippe Mercier, et al., “Drone vs. bird detection: Deep learning algorithms and results from a grand challenge,” Sensors, vol. 21, no. 8, pp. 2824, 2021, incorporated herein by reference in its entirety. Second, is an IR dataset called AntiUAV-IR. See Nan Jiang, Kuiran Wang, Xiaoke Peng, Xuehui Yu, Qiang Wang, Junliang Xing, Guorong Li, Jian Zhao, Guodong Guo, and Zhenjun Han, “Anti-uav: A large multi-modal benchmark for uav tracking,” ar Xiv preprint arXiv: 2101.08466, incorporated herein by reference in its entirety. The RGB images were obtained by converting 77 videos from Drone-Vs-Bird dataset to 105,593 images and 152,567 IR images were obtained by converting 140 videos from AntiUAV-IR dataset to images. Given the large number of samples from these datasets, the obtained results are more significant and reliable than work based on small datasets.

The results of all of the conducted experiments are presented in Table 2. As shown in this table, SSD performed the best as a one-stage detector in both RGB and IR datasets. The experimental results of the modified SSD with AdderNet backbone and a path to add low-level features with high-level features show comparable performance to the original SSD and YOLO. SWIN transformer as a backbone for the SSD model performed the lowest compared to the other models on the RGB dataset. Similarly, in the IR domain, the proposed models performed nearly the same as the state-of-the-art one stage detectors. It is important to note that the performance of the modified SSD with AdderNet backbone and the feature path has 90.4G less multiplications than the original SSD model. Hence, it preserves accuracy while reducing complexity.

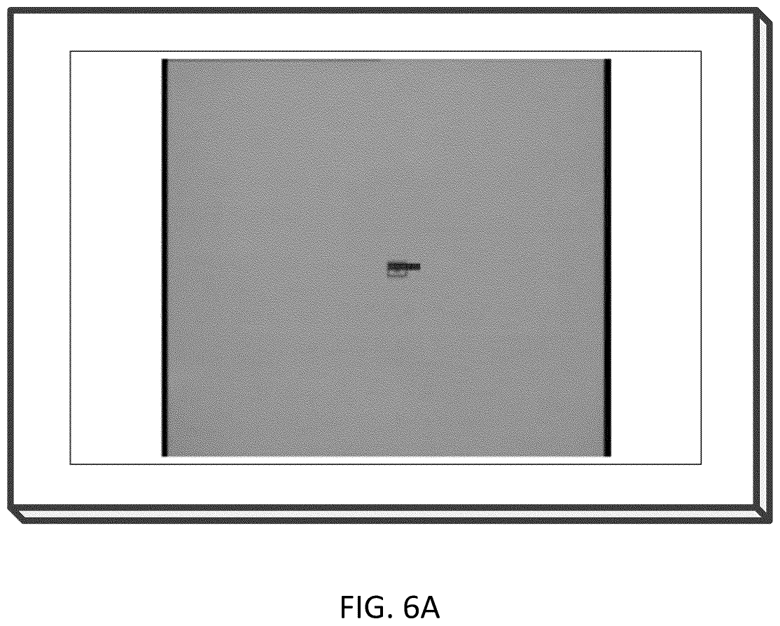

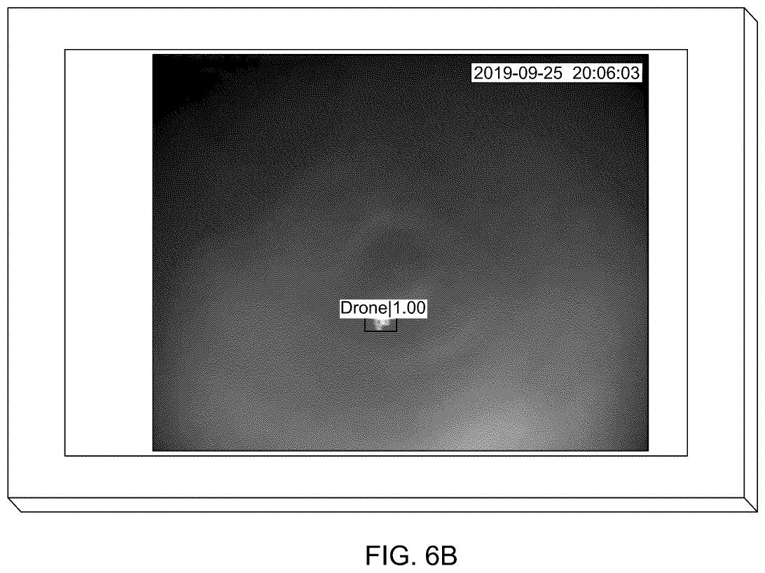

FIGS. 6A and 6B illustrate exemplary output images having a detected drone object. In one embodiment, an output of the modified SDD is a display of an image including a bounding box for the detected drone object. FIG. 6A illustrates an RGB image. FIG. 6B illustrates an infrared image. Moreover, the results show that all models have increased performance when dealing with IR images. This is because IR images have features such as uniformity in background and brightness at the target, making detecting drones regardless of the size an easier task than RGB images.

TABLE 2
Results

| Dataset | Model | AP | AP_{0.5} | AP_{0.75} | APₐ | APₘ | APₗ |
|---|---|---|---|---|---|---|---|
| Drone-Vs- | SSD | 0.247 | 0.626 | 0.175 | 0.168 | 0.527 | 0.655 |
| Bird | YOLO | 0.241 | 0.614 | 0.133 | 0.165 | 0.504 | 0.644 |
| | SSD with AdderNet | 0.235 | 0.587 | 0.126 | 0.159 | 0.443 | 0.237 |
| | Backbone and Path | | | | | | |
| | SSD with SWIN | 0.212 | 0.559 | 0.106 | 0.13 | 0.411 | 0.517 |
| | Transformer | | | | | | |
| AntiUAV- | SSD | 0.503 | 0.840 | 0.545 | 0.35 | 0.626 | — |
| IR | YOLO | 0.482 | 0.825 | 0.512 | 0.348 | 0.609 | — |
| | SSD with AdderNet | 0.403 | 0.718 | 0.403 | 0.327 | 0.474 | — |
| | Backbone and Path | | | | | | |
| | SSD with SWIN | 0.467 | 0.833 | 0.469 | 0.310 | 0.590 | — |
| | Transformer | | | | | | |

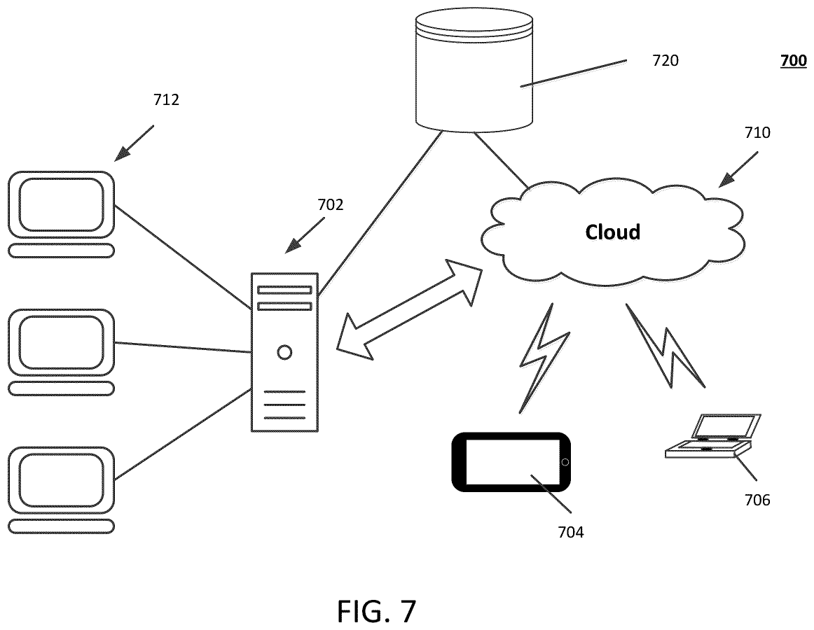

FIG. 7 is a diagram of a machine learning system in accordance with an exemplary aspect of the disclosure. The reduced computational complexity has enabled faster training and training with a large number of training images. However, the detection of objects that are very small relative to an overall image, the more example images, the better probability of success in detecting a wide variety of drone objects. In an exemplary embodiment, a server 702 or artificial intelligence (AI) workstation may be configured for training detection of drone objects. With such a configuration, one or more client computers 712 may be used to perform training of detection for several drone object classes at a time. In the embodiment, the server 702 may be connected to a cloud service 710. The cloud service 710 may be accessible via the Internet. The cloud service 710 may provide a database system and may store source code for a system. Mobile devices 704, 706 may access images served by the cloud service 710.

An aspect is a drone object detection service having one or more servers 702 and one or more client computers 712. The drone object detection service can determine whether an image contains at least one drone object and take appropriate action, such as notify of a drone object or insert a label that indicates that the drone object has been detected.

Another aspect is a drone object detection software application that any user of a display device will be made aware that a drone object is contained in an image. The drone object detection software application may be configured to run in the background as a daemon, or be configured to be invoked by a command and/or function associated with a graphical widget. In addition, objects that have been determined to be drone objects may be stored in a database 720 containing drone images. The database 720 may be maintained in a server computer or in a cloud service 710.

In some embodiments, a drone object detection service may include a drone object detection system of the present disclosure. The drone object detection system may perform an operation of detecting drone objects, or other action based on a setup function of the service. The service may be setup to label classes as being drone objects, store classes in a separate distribution channel, or other action under the discretion of the drone object detection service.

In some embodiments, the drone objects detection system of the present disclosure may take the form of a product, such as a drone object detector device or software application. The drone object detector device or software application may be connected to a image uploading service 710 and may capture images distributed by the image uploading service in order to determine if an image includes a drone object. The drone object detector device or software application may be incorporated into a network system as middleware that is connected between an image uploading service 710 and an end user display device 704, 706. An object that is detected as being a drone object may be subjected to a follow-up action, such as inserting a label into the image as an indication that it has been detected as being drone object. Another action may be to redirect those videos detected as being drone objects into a database 720 storing drone object images, for example, to be further analyzed, or separately distributed in a drone object channel.

In some embodiments, a drone object detector may be a mobile application that can be installed in a mobile display device 704, 706. The drone object detector mobile application may inform the user of the mobile display device that an object is a drone object, by for example, displaying an indication message, or outputting an audio sound or voice message, in order to make the user aware that a source code has been detected as being a drone object.

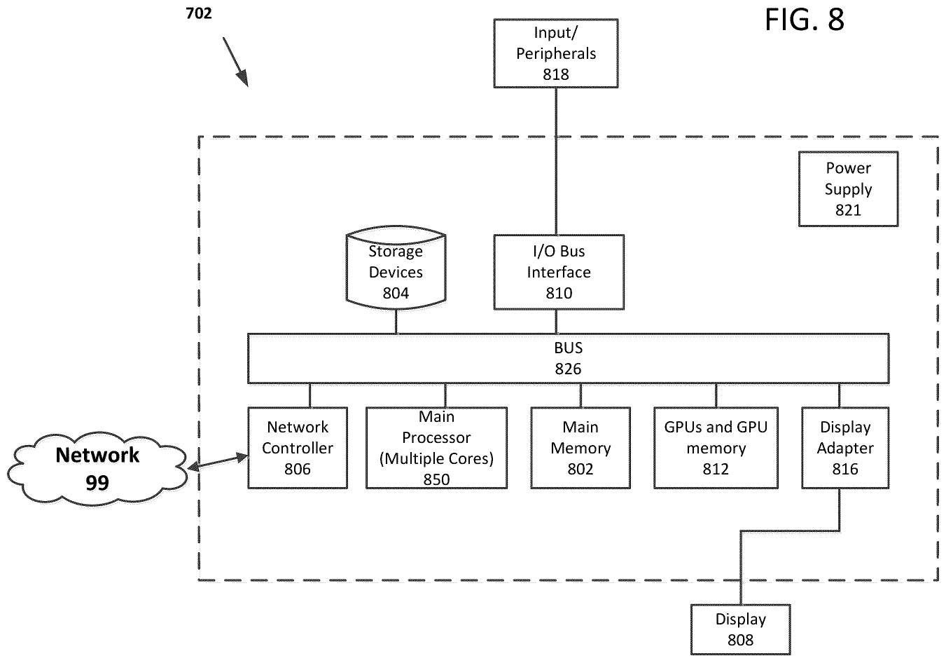

FIG. 8 is a block diagram illustrating an example computer system for implementing the machine learning training and inference methods according to an exemplary aspect of the disclosure. The computer system may be an AI workstation running an operating system, for example Ubuntu Linux OS, Windows, a version of Unix OS, or Mac OS. The computer system 800 may include one or more central processing units (CPU) 850 having multiple cores. The computer system 800 may include a graphics board 812 having multiple GPUS, each GPU having GPU memory. The graphics board 812 may perform many of the mathematical operations of the disclosed machine learning methods. The computer system 800 includes main memory 802, typically random access memory RAM, which contains the software being executed by the processing cores 850 and GPUs 812, as well as a non-volatile storage device 804 for storing data and the software programs. Several interfaces for interacting with the computer system 800 may be provided, including an I/O Bus Interface 810, Input/Peripherals 818 such as a keyboard, touch pad, mouse, Display Adapter 816 and one or more Displays 808, and a Network Controller 806 to enable wired or wireless communication through a network 99. The interfaces, memory and processors may communicate over the system bus 826. The computer system 800 includes a power supply 821, which may be a redundant power supply.

In some embodiments, the computer system 800 may include a server CPU and a graphics card by NVIDIA, in which the GPUs have multiple CUDA cores. In some embodiments, the computer system 800 may include a machine learning engine 812.

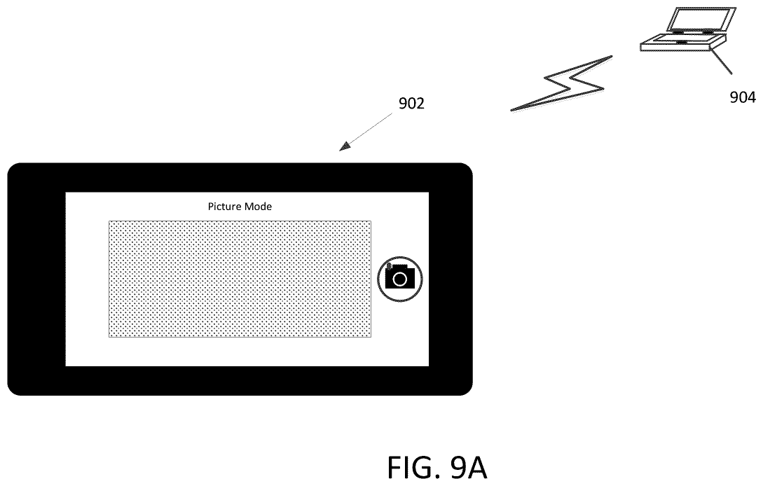

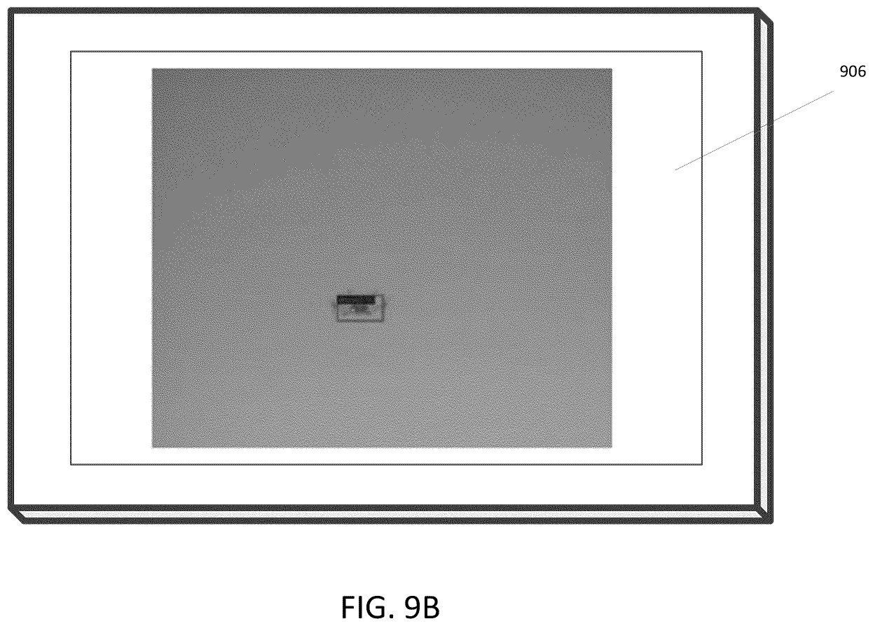

FIGS. 9A and 9B is a system diagram for an exemplary drone detection application. In one embodiment, the modified SDD for drone detection may perform inference in a mobile device 902 that is equipped with a camera and display. In one embodiment, an object that is detected by the mobile device 902 may alternatively be displayed on another display device for closer inspection, such as a laptop computer 904. FIG. 9B is an example external display 906 for an object that is detected in the mobile device 902.

The modified SDD has been found to produce superior detection results for small drone objects. However, the modified SDD is not limited to detection of small drone objects. As mentioned above, objects can also appear small in an image because the object is at a great distance from the image capture device. Moving vehicles can also benefit from the modified SDD. For example, it would be beneficial to detect an object that is far ahead of a moving vehicle, especially at speeds that vehicles typically travel at. An object in the road far ahead of the moving vehicle could be an animal or even a person, but at a certain distance may be difficult to identify. The modified SDD may be trained to identify objects that appear small in an image obtained using a camera in a moving vehicle. In such case, the moving vehicle can be configured to take appropriate action in a timely fashion.

The modified SDD can also be used to detect other types of objects in the air, including, but not limited to, helicopters, small airplanes, balloons, missiles, to name a few. A mobile device, e.g., camera equipped smartphone, may be configured for object detection by the modified SDD.

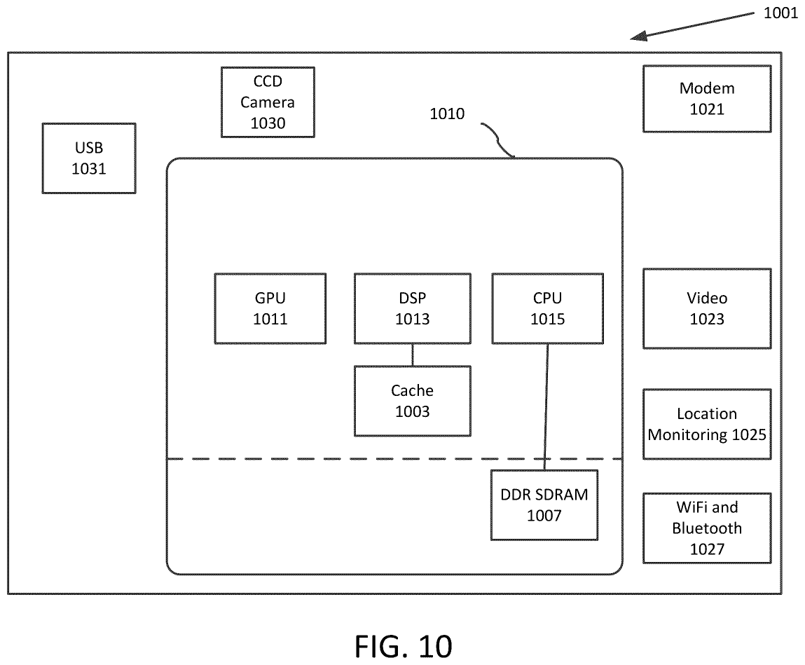

FIG. 10 is a block diagram of a display processing system for the human machine interface in accordance with an exemplary aspect of the disclosure. The display processing system 1001 provides support for simultaneous camera sensor inputs, video decoding and playback, location services, wireless communications, and cellular services. In one embodiment, the display processing system 1001 is the mobile device 902. The display processing system 1001 includes a central processing unit (CPU) 1015, and may include a graphics processing unit (GPU) 1011 and a digital signal processor (DSP) 1013. The CPU 1015 may include a memory, which may be any of several types of volatile memory 1007, including RAM, SDRAM, DDR SDRAM, to name a few. The DSP 1013 may include one or more dedicated caches 1003 in order to perform computer vision functions as well as machine learning functions. The GPU 1011 performs graphics processing for a 4K resolution display device. The GPU 1011, DSP 1013, CPU 1015, Cache 1003, and in some embodiments, a cellular modem 1021, may all be contained in a single system-on-chip (SOC) 1001. The display processing system 1001 includes a video camera 1030, in particular a CCD camera. The display processing system 1001 may also include video processing circuitry 1023 for video decoding and playback, location service circuitry 1025, including GPS and dead reckoning, and connectivity service circuitry 1027, including WiFi and Bluetooth. The display processing system 1001 may include one or more input/output ports, including USB connector(s) 1031, such as connectors for USB 2, USB 3, etc.

Numerous modifications and variations of the present invention are possible in light of the above teachings. It is therefore to be understood that within the scope of the appended claims, the invention may be practiced otherwise than as specifically described herein. The modified SDD can be configured to extract informative features from small objects to increase the accuracy of small drone detection.

1. An object detection system, comprising:
a camera for capturing an image;
processing circuitry configured to
input the image,
a machine learning network, including
a feature extraction backbone having addition-based filters that use addition as a similarity measure to extract features of the image, and
a single shot detector (SSD) network that outputs an image with possible classes of an object in the image based on the extracted features; and
a display device to display the image with a label for the detected object based on a selected class.

2. The object detection system of claim 1, wherein
the feature extraction backbone includes a path structure that adds the output of the backbone to a kernel having dimensions of an initial layer of the backbone.

3. The object detection system of claim 1, wherein
the machine learning network is trained for detection of a drone object,
wherein the display displays the image with a label for the detected drone object.

4. The object detection system of claim 1, wherein the SSD is trained using a learning rate that decays from 2×10⁻³ to 2×10⁻⁶.

5. The object detection system of claim 1, wherein the object in the image substantially occupies 10% or less of a total area of the image.

6. The object detection system of claim 1, further comprising:
a mobile device including the camera.

7. The object detection system of claim 6, further comprising:
a portable computer system including the processing circuitry and the display device.

8. An object detection system, comprising:
a camera for capturing an image;
processing circuitry configured with
a single-shot detector (SSD) network backbone for extracting features of the captured image, and
a SSD network head that outputs classes of the object in the image based on the extracted features,
wherein the SSD network backbone uses a SWIN transformer to extract features, wherein the SWIN transformer includes a shifted window self-attention; and
a display device to display the image having a label for the detected object based on the output class.

9. The object detection system of claim 8, wherein
the SSD network is trained for detection of a drone object,
wherein the display device displays the image with a label for the detected drone object.

10. The object detection system of claim 9, wherein the object in the image substantially occupies 10% or less of area of the image.

11. The object detection system of claim 8, further comprising:
a mobile device including the camera.

12. The object detection system of claim 11, further comprising:
a portable computer system including the processing circuitry and the display device.

13. A method of detecting an object in an image, comprising:
capturing, via a camera, an image;
inputting, via processing circuitry, the image;
extracting, via the processing circuitry, using a backbone network features of the image by using addition as a similarity measure;
determining, via the processing circuitry, using a head network an image with possible classes of an object in the image based on the extracted features; and
displaying, via a display device, the image with a label for the detected object based on a selected class.

14. The method of claim 13, further comprising:
adding, by way of a path structure, the output of the backbone network to a kernel having dimensions of an initial layer of the backbone network.

15. The method of claim 13, further comprising:
training the backbone network and the head network for detection of a drone object; and
displaying, via the display device, the image with a label for the detected drone object.

16. The method of claim 13, further comprising:
training the backbone network and the head network using a learning rate that decays from 2×10⁻³ to 2×10⁻⁶.

17. The method of claim 13, wherein the object in the image substantially occupies 10% or less of a total area of the image.
